(19) United States
(12) Patent Application Publication
(10) Pub. No.: US 2011/0155983 A1
(43) Pub. Date: Jun. 30, 2011

(54) Support Structure for a Screen

(75) Inventor: Tom Westcott, Cherrybrook (AU)

(73) Assignee: SAAB AB, Linkoping (SE)

(21) Appl. No.: 11/663,916

(22) PCT Filed: Sep. 27, 2005
(86) PCT No.: PCT/AU2005/001479

§ 371 Date: Mar. 3, 2008

(30) Foreign Application Priority Data
Sep. 27, 2004 (AU) 2004905581

(51) Int. Cl. E04H 17/22; F16M 13/00; E04H 17/16

(52) U.S. Cl. 256/24; 211/60.1

(57) ABSTRACT

An elongate support member for use in a support structure for a screen made from flexible screen material. The support member is adapted to receive one or more elongate rolls of the screen material. The support member is a visually impenetrable beam whose sectional configuration defines an open W-shaped or M-shaped profile.

### FIELD OF THE INVENTION

The invention relates to the field of portable or non-permanent outdoor screens. In particular, the invention relates to an improved support structure for said screens.

### BACKGROUND TO THE INVENTION

There is an increasing demand for opaque structures which can be used to prevent physical and or visual access by unauthorised persons to a predetermined area. This need may arise, for example, where an organisation wishes to utilise an open and otherwise public space for a private function; where an otherwise open public sporting field is to be temporarily used for a “ticket only” purpose; or where a military organisation wishes to prevent visual access (“counter observation”) to a temporary or semi-permanent military operations area, among other things.

For may such applications, particularly where the counter observation function is anticipated to be temporary, it is necessary that these structures can be transported, erected and dismantled with relative ease and without the need for specialised equipment, while nevertheless providing an effective counter observation barrier, which may be up to four meters in height.

Temporary, or semi-permanent, counter observation screens which have been used to date tend to suffer from one of two shortcomings. Since an effective counter observation screen needs to be relatively tall, support structures for such screens are often quite heavy, necessitating the use of cranes or other equipment to both transport and erect such structures. They also require considerable time and labour during erection and dismantling due to the quite heavy and complicated structures which need to be employed to successfully maintain an erect screen.

One way which has been used in an attempt to overcome this kind of deficiency is to provide aluminium poles mounted into ground holes, which are specifically provided for this purpose, while suspending the screen material between the poles. However, this kind of solution is not always appropriate, particularly where no such pre-arranged ground holes are provided, or where the screen is to be used as a rapidly deployable counter observation measure for a highly mobile military unit. Any saving which can be made in the weight and complexity of the structure for transport purposes, in the complexity and number of parts involved, for purposes of rapid and reliable deployment, or in the ability of the structure to be deployed in all terrains and any position of choice without need for extensive site preparation, for purposes of rapid deployment, would provide a great advantage over existing prior art systems.

Alternatively, those known prior art systems which are relatively light and easy to deploy tend not to ultimately work very effectively as counter observation screens. For example, it is quite common that continuous screening is not actually achievable throughout the structure. For example, prior art systems often involve a “gap” between the screening material and the support structure, through which the “private” area may in fact be observed. Such screens also tend to have relatively low strength and wind resistance, often making them unreliable in practice.

Therefore, it is an object of the present invention to provide a support structure for a counter observation screen, and a counter observation screening system, which is relatively portable, able to be deployed in a wide variety of positions, relatively simple to erect, but which nevertheless effectively screens visual access up to a height of four meters. In this regard, it will be noted that effective screening of visual access will not be understood to mean absolute visual impenetrability, but is a practical definition entailing that any person who does seek visual access to the screened area will be required to do so in a manner which would inevitably draw attention to themselves, for example by scaling a four meter ladder adjacent the screen, or by damaging the screening material in some way.

### SUMMARY OF THE INVENTION

According to the invention there is provided an elongate support member for use in a support structure for a screen made from flexible screen material, said support member being adapted to receive one or more elongate rolls of said screen material, wherein said support member is a visually impenetrable beam with a cross-sectional configuration defining essentially an open W-, M- or 3-shaped (depending on orientation) profile, the beam having:

two roll-housing channels extending parallel with and along the longitudinal axis of the beam and being open at a front side of the beam, the channels adapted to receive said elongate rolls; and

an intermediate ridge disposed between and partly defining said roll-housing channels and extending parallel with and along the longitudinal beam axis, said ridge defining a central channel which is open at a rear side of the beam.

An advantage of such type of beam is that it provides a high degree of bending and torsional strength and is a relatively simple and easy to manufacture structure. It also allows a screen structure to be constructed which is effectively visually impenetrable, as the roll-housing channels will receive the screen rolls to which are secured terminal ends of screen fabric, thereby avoiding gaps at the anchoring point of the screen material to the support members used in such structure. Another advantage of such beam layout is that the three-channel profile allows attachment of auxiliary support beams at a variety of different points at the centre channel of the beam, depending on the most appropriate construction for the overall screen structure.

A further advantage provided by the profile shape is that it possesses an acceptable moment of inertia (of the cross-section), thereby assisting in width-standing deflections under load, particularly in a direction along a traverse axis which intersects the (notional) longitudinal axes of the two roll-housing channels, to resist the large tensile forces which may be applied to the beam when deployed vertically and supporting a tensioned fabric screen of up to four metres in height along the length of the beam.

The roll-receiving channels are designed to receive rolls of the screening material, and thus their width may be choosen to suit a given application, said screening material then intended to extend outward from said rolls, beyond the outer wall of said roll-receiving channels and toward the next support member in a series of such members that form part of a screen structure.

Preferably, the height of said intermediate ridge is approximately half of the depth of the two roll-receiving channels. It has been found that such a profile cross-section provides an acceptable level of overall bending and torsional strength of the section, while allowing the necessary clearance to allow structural bolts to be fitted onto the ridge (as well as the central channel defined by the ridge walls) without unduly impinging on the position of rolls of fabric inserted in the roll-receiving channels.

Advantageously, the beam profile is symmetrical about a central longitudinal axis running along the intermediate ridge. This ensures symmetric loading and bending strength of the beam, as well as simplifying the manufacture of same.

The free, longitudinally extending terminal ends of said profile are advantageously bent backwards so as to provide a rounded glide surface to facilitate the smooth transit of screen material across said ends when being tensioned. This measure also improves the bending strength of said beam.

A preferred method of manufacture of the beam according to the invention is roll forming, from a flat-plate metal blank, eg steel sheet material, high tensile strength aluminium as similar. This method of construction is relatively cost effective, and provides a strong and durable structure for the beam. Alternatively, it is possible to manufacture the beam by in a pressing or flat drawing operation.

Preferably, said blank is, before being formed into the M-, W- or 3-shaped profile, initially 600 mm wide and between 1 mm and 3 mm thick. A beam manufactured from sheet material with the above dimensions is likely to have enough buckling strength to allow pile driving the beam into the ground, as a simple method of erection of a screen, if desired.

An alternative method of manufacture of the beam according to the invention is to extrude the profile directly from aluminium, eg a suitable high strength alloyed aluminium.

Preferably, the profile of said roll-housing channel is defined by a flat rear wall connected to said intermediate ridge and connected to a flat outer side wall by a bevelled return wall. The bevelled corners provide additional stiffening folds to the rear face of the beam. This configuration also provides a V-shaped cavity which may more securely contact an axially deflected roll of screen material when placed under tension.

This configuration also allows a front and rear strut of equal length to be fitted either fore or aft of the beam, as part of a beam support structure.

Advantageously, the profile of said roll-housing channel is further defined by a flat outer side wall having a terminal end, wherein said terminal end features a rounded return surface. Preferably, this rounded return surface is provided by a terminal fold of the steel material. Such a fold provides further stiffness to the outer section of the beam and provides for snag-free passing of the screen material across the end of the beam as it is extended toward the next beam in the support structure.

In another aspect of the invention, there is provided an erectable screening structure, including a sheet of opaque flexible screen material having terminal ends anchored at two elongate roll cores in a scroll-like configuration allowing unwinding and winding-up of screen material onto one or both rolls; first and second support structures each of which include a support element (beam) as defined above and which further include header and footer anchoring structures close or at longitudinally opposite ends of the beams; and two ground anchoring structures devised to allow vertical anchoring of the two support structures in spaced apart relationship on the ground, wherein said roll cores are secured to said support members between said header and footer members in rotatable manner and located in a respective one of the roll-housing channels of the respective beams that are closest to one another, and wherein said screen material, in deployed state, extends from a shed point on the outer periphery of the roll located in the roll-housing channel of the first support structure, via contact with the immediately adjacent terminal end of the profile of the first support structure beam, towards said second support structure, via contact with the immediately adjacent terminal end of the profile of said second support structure beam, to a shed point on the outer periphery of the roll located in the roll-housing channel of the second support structure beam, thereby to create a visually substantially impenetrable zone where the screen material meets the support structure beams.

The above screen support structure module takes advantage of the various superior properties of the structural support member described above. In particular, it will be noted that this arrangement, when viewed from the rear, or closed, side of the beam, is visually impenetrable in that the support structures between which the screening material is tensioned are themselves visually impenetrable and the opaque screening material emerges from behind said structures. Arranging a number of such support structures in a line (like a fence), and locating (securing) at each structure one of the two rolls onto which individual screening material fabric “panels” are rolled up, will enable to create a screened-off zone. Effectively, therefore, there is no “gap” in the screen where the screening fabric is anchored to the support post structures which may otherwise allow a casual observer to “peek” into the visually screened off area.

In a particularly preferred embodiment of the screen structure, the roll cores are sufficiently flexible that they will deform axially so as to allow the outer surface of said rolls to make frictional contact with the inner surface of said roll-housing channels when said screen material is placed in tension between two neighbouring support structures. Effectively, tensioning of the screen material causes the roll cores to bend in a manner which causes them to bend towards the walls of the channel and frictionally “jam” on said channel wall. This allows the screen material to be held tightly in place. In particular, it is preferred that the axes of rotation of the roll cores, when not subjected to tension, are coplanar with the terminal or “innermost” surface of the intermediate ridge. The reason for this is that where this part of the ridge is to be used as an anchor point for a brace, the bracing will accordingly be effectively anchored at a point equidistant from the front and rear points of the beam, allowing braces of equal length to be used, regardless of the side of the support structure beam to which they are anchored.

Particularly advantageously, it is preferred that the screen material is rolled onto the roll cores in a manner which would tend to cause a roll core to deform toward the outer wall of said roll-housing channels when said screen material is placed in tension.

Effectively, this means that the material wound onto the roll core is oriented in such a way that when viewed from above by an observer facing the open side of the beam, the roll on the left-hand channel, when unravelled towards the left, would rotate in a clockwise direction, and the roll in the right-hand channel, when unravelled towards the right would rotate in an anticlockwise direction. The reason for choosing such a configuration is that the roll core would then tend to deform towards, and jam frictionally against, the part of the channel wall which tends to provide the greatest frictional contact and therefore support for the roll.

Now will be described, with reference to specific, non-limiting examples, a number of preferred embodiments of the invention.

### BRIEF DESCRIPTION OF THE DRAWINGS

FIG. 1 is a cross-sectional view of a beam according to one aspect of the invention;

FIG. 2 is a perspective, partial view of the beam of FIG. 1;

FIG. 3 represents a combined rear plan view, side elevation and end elevation view of support structure according to another aspect of the invention, comprising a beam according to FIGS. 1 and 2, and header and footer end structures secured to the beam, multiple such structures being devised to form poles of a screen structure according to another aspect of the invention;

FIG. 4 is a detailed view of the header and footer end structures secured to the beam of FIG. 1 and illustrated in FIG. 3;

FIG. 5 is a cross-sectional view of the support structure (port) of FIGS. 3 and 4 in which are housed two screen material tuff rolls and which structures and screen form part of the screen structure when in deployment as a screen according to the invention;

FIG. 5a is the cross-sectional view of FIG. 5, showing exemplary dimensions of a preferred embodiment of the support structure beam.

FIG. 6 is a rear elevation of a support structure as per FIG. 3, in a partially installed position, illustrating one form of a bracing structure which may be used to provide additional support to the support structure when in use as part of a screen;

FIG. 7 is as per FIG. 6, showing an alternative bracing structure;

FIG. 8 is a cross-sectional view of a component of an aluminium luff pole which is used to assemble a roll core for the screening material, as per a preferred embodiment of another aspect of the invention;

FIG. 9 is a plan and elevation view of a luff pole tensioner which may be used in conjunction with a luff pole formed from two components illustrated in FIG. 8, as per a preferred embodiment of the invention;

FIGS. 10a and 10b are rear and front elevations of a counter observation screen, employing a polarity of support structures as per FIGS. 3 to 7, as per a preferred embodiment of the present invention;

FIG. 11 shows cross-sectional or top plan views of two alternative arrangements of twin beams for mounting a double-screen version of the invention.

### DETAILED DESCRIPTION OF A PREFERRED EMBODIMENT

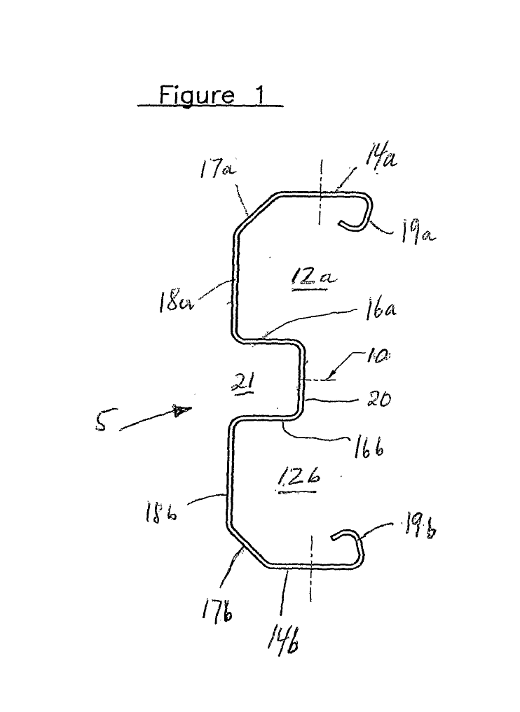

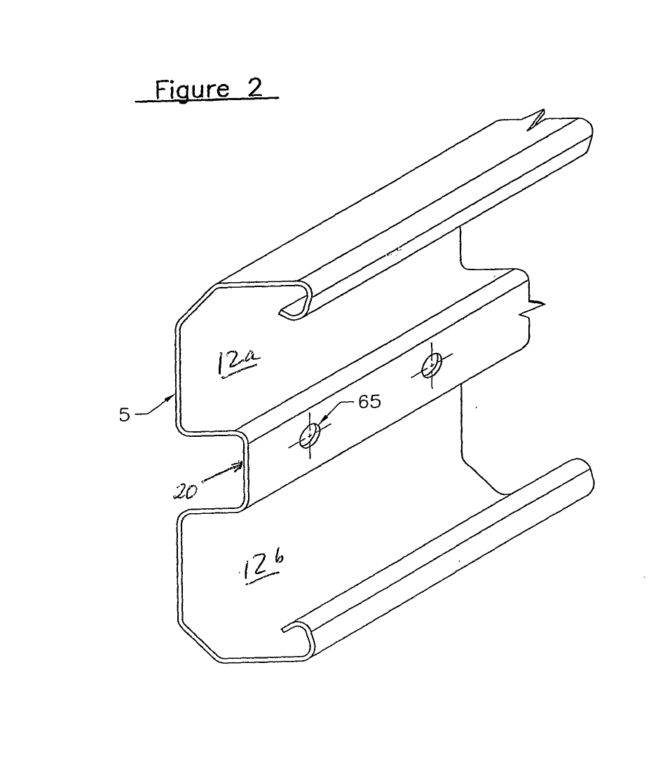

Turning first to FIGS. 1, 2 and 5a there is shown in cross-section and in isometric views, a beam 5 embodying one aspect of the present invention. The beam 5 has a cross-sectional profile formed via roll-forming of a steel sheet blank of width of approximately 600 mm and thickness of between 1 to 3 mm, depending on mass and strength requirements. The selection of a 6000 mm sheet blank is preferable, as standard commercially available steel sheet is approximately 1200 mm wide, allowing two blanks to be out from one sheet without waste.

Once folded into the configuration/profile shown in FIGS. 1, 2 and 5, the overall width of the beam is about 280 mm, and the depth is about 100 mm.

The beam section is symmetrically formed about a central plane 10. The overall section or shape of the beam section resembles a “W”, “M” or “3”, depending on its orientation. This shape essentially defines two identical channel regions 12a, 12b which are each devised to house, in use and as will be described below, a luff pole about which is wrapped flexible sheet material that may serve as a screen. The channels 12a, 12b are bordered by an outer wall section 14a, 14b, an inner wall section 16a, 16b and a rear wall section 18a, 18b. The channels 12a, 12b are separated by a central ridge which comprises a front wall section 20 and the two inner side wall sections 16a, 16b of the channels 12a, 12b, respectively. The ridge, on its obverse face, defines a third channel 21. It will be noted that a bevelled corner section 17a, 17b is provided between outer wall section 14a, 14b and the rear wall sections 18a, 18b, and each outer wall section 14a, 14b terminates in beaded (or backward bent) edge zones 19a, 19b.

The overall “fold” arrangement of the individual wall sections lends considerable stiffness and bending strength to the beam 5, in particular the bent terminal ends 19a, 19b increase bend resistance. The preferred grade of steel for the beam is 350 MPA. Alternatively, the beam may be manufactured from high tensile strength, alloyed aluminium, and may be extruded with the illustrated cross-section.

As will be noted from FIG. 2, the beam 5 has a number of bolt-holes 65 in the front wall section 20 of the central ridge between channels 12a, 12b, which will aid in the attachment of bracing and other structures. It is preferred that these bolt holes have a diameter of approximately 18 mm and are spaced along the longitudinal axis of the beam at approximate centres of 100 mm.

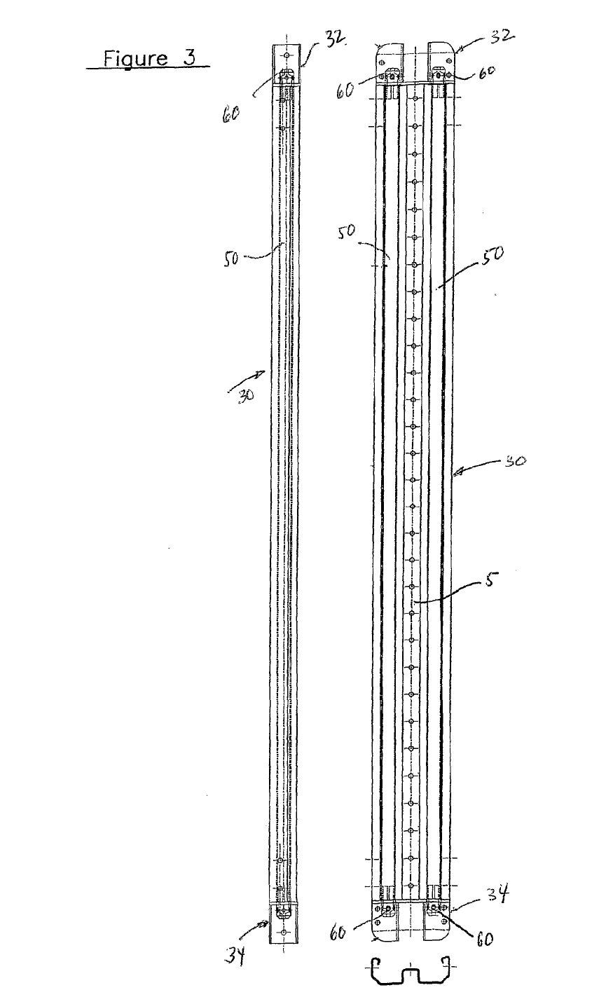

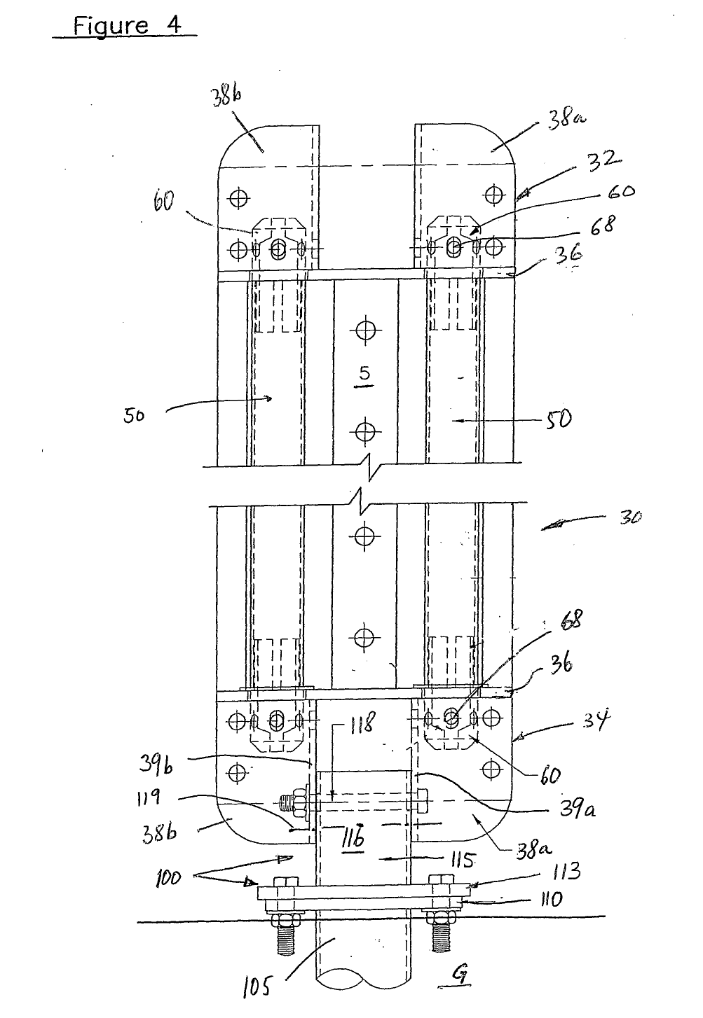

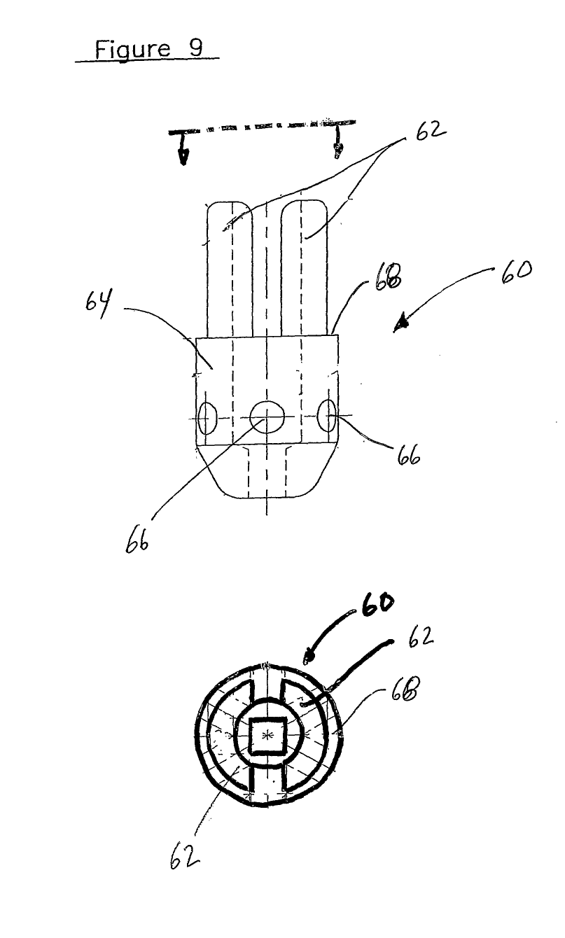

Turning to FIGS. 3 and 4, there is shown a rear, side and plan end view of a vertical support post (or structure) 30 for use in a screening fence (or structure) 1, as per another aspect of the invention. Post 30 comprises a beam 5 as illustrated in FIGS. 1 and 2, to which are secured at both axial terminal ends respective header and footer structures 32; 34, eg by way of welding. Both header and tooter structures 32, 34 are identical to one another, thereby avoiding an orientation preference when erecting a screening fence utilizing such support posts 30. The header (and footer) structures 32, 34 comprise a base plate 36 caping the open terminal ends of the profile 5, and a pair of L- (or u-) sections 38a, 38b upstanding from base plate 36 in spaced apart arrangement to define a two-legged mounting pedestal as illustrated. FIG. 3 also illustrates how a pair of luff poles 50 are secured in rotatable but otherwise axially anchored manner to the header and footer assemblies 32, 34 via luff pole tensioners 60 (see also FIG. 9) located at both top and bottom ends of said luff poles 50, as described below.

FIG. 4 shows in greater detail the mount for the luff poles 50 at the header and footer structures 32, 34 of the vertical support post 30, and a ground anchoring structure 100 intended for securing the post 30 to the ground G.

It will be noted that the ground support structure 100 includes a sunken concrete pier 105 with a top anchoring plate 110 to which is bolted in known manner a bottom anchoring plate 113 of a steel pedestal 115 having an upright pedestal stump 116 of quadrilateral cross-section. The footer structure 34 of post 30 is anchored to the steel pedestal 115 in pivotable manner, wherein pedestal stump 116 is received between facing mounting plates 39a, 39b that form one of the legs of the L- or U-sections 38a, 39b, welded to the footer base plate 36, in such manner that respective diameter-identical through-holes provided in stump 116 and mounting plates 39a and 39b are aligned, thereby enabling fastening bolt 118 to secure the post 30 to the anchoring structure 100. The entire support post structure 30 may thus pivot about the fastening bolt axis. This allows the whole structure to be readily ‘laid flat’ if circumstances require, such as high wind conditions or the need to rapidly deploy military assets toward an outside of a screen that employs a plurality of such posts 30, as described below. It also allows easier erection of the screen, allowing the screen to be assembled on the ground, and then “pushed up” into a vertical position, potentially manually, prior to tensioning of the textile screen material supported between neighbouring posts 30 (see below).

In order to secure the posts 30 in an upright orientation and against pivoting about their respective anchoring structures 100, a second (locking) bolt, illustrated schematically at chain-dotted line 119 is inserted into aligning through holes in the pedestal stump 116 and mounting plates 39a, 39b that are located below (or above) the mounting bolt; i.e. a parallel double bolt attachment of post 30 to anchoring structure 100 is provided. Alternative structures may be used to secure the post 30 in upright deployment, as known to the skilled engineers e.g. by bracing struts or tensioning cables, as is alluded below.

Reverting to the luff poles 50, a pair of these are anchored to and between the base plates 36 of header and footer structure 32, 34 respectively so as to be retained against removal but allow rotation about the longitudinal axis of each pole 50. To this end, any suitable mounting arrangement may be devised, e.g. the base plates 36 of the header and tooter structures 32,34 may be suitably provided with through holes in which the axially opposite ends of the pole 50 may be appropriately secured.

The luff poles 50 themselves are provided with tensioners 60 inserted into the respective longitudinal terminal ends of the poles. These luff pole tensioners 60 (see also FIG. 9) feature two legs 62 of about half-circular cross-section, which are received in similarly shaped cavities inside the luff poles 50 in a manner which secures the tensioners 60 against free rotation at the luff poles 50. The tensioners 60 also feature a cylindrical head 64 which protrudes from the luff pole ends, the spherically capped head 64 featuring six bolt holes 66 in star configuration, and a collar 68 which rests on the horizontal base plate 36 of the header and footer structures 32, 34, respectively,

The head 64 of the tensioner 60 is devised such that it can be connected to a standard half-inch drive ratchet mechanism, which is used to rotate the luff poles 50 in a manner which would cause tightening of screen material (not shown) unwound from luff poles 50. The screen panel may then be held in tension by the insertion of a pin (68 in FIG. 4) through one pair of bolt holes 66 of the tensioner 60, which prevents the luff poles 50 from rotating.

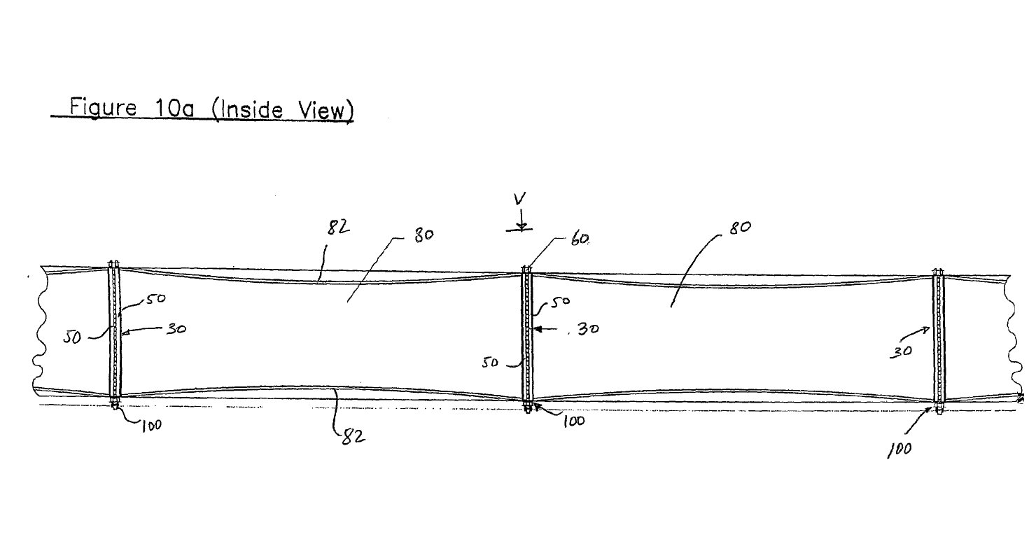

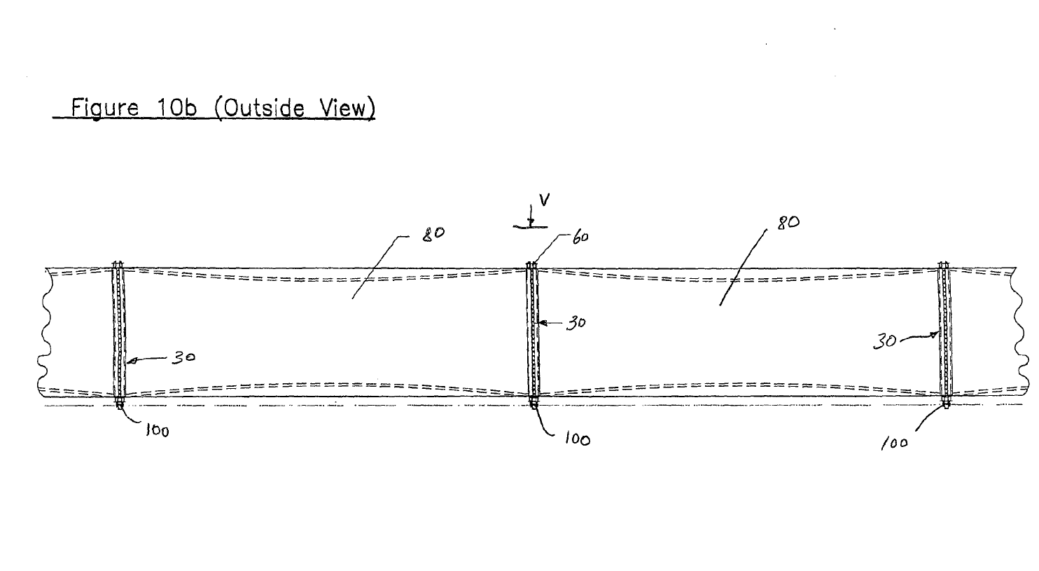

A screen fencing structure in accordance with a further aspect of the present invention, consisting of a number of support structures (support posts 30 with ground anchoring structures 100) as described above and which deploy a textile, optically opaque screening sheet 80 between neighbouring post structures, each screen sheet being rolled-up scroll-like into two rolls respectively, and received on the luffing poles 50 of neighbouring posts 30, is shown in FIGS. 10a and 10b. The figures depict a partial view of the entire fencing structure from inside and outside of a screened-off area, respectively. It will be noted that additional screen support cables 82 extend between upper and lower ends, respectively, of neighbouring support posts 30, and are tensioned in appropriate manner. These tensioning cables may also form part of or be integrated with the screening sheet material 80 and be rolled-up together with the screening material.

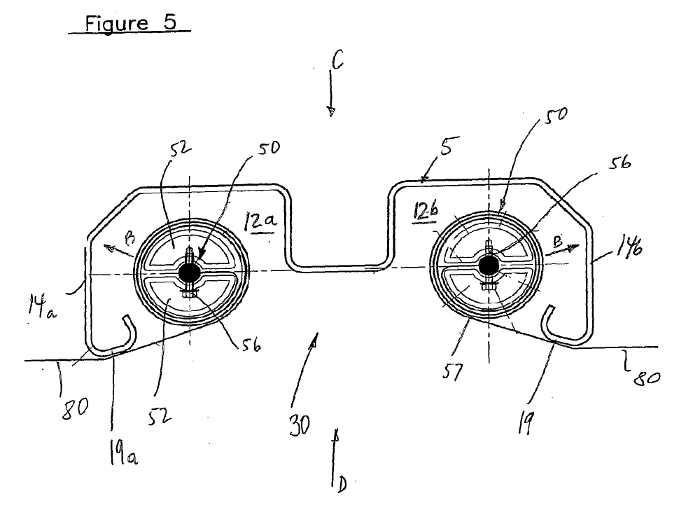

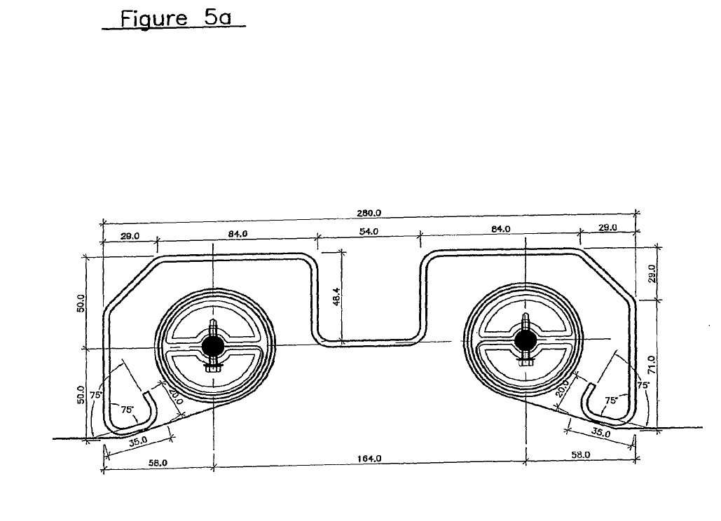

It will be noted that the use of multiple support post structures 30, each carrying two screening sheet rolls in the respective receiving channels 12a, 12b of the upright beams 5, enables the entire structure to be erected without gaps being present in the areas where the screen material panels deploy from the posts. This is also more clearly illustrated in FIG. 5, where is shown a schematic top plan view of a single support (post structure 30, along arrow V in FIGS. 10/10a.

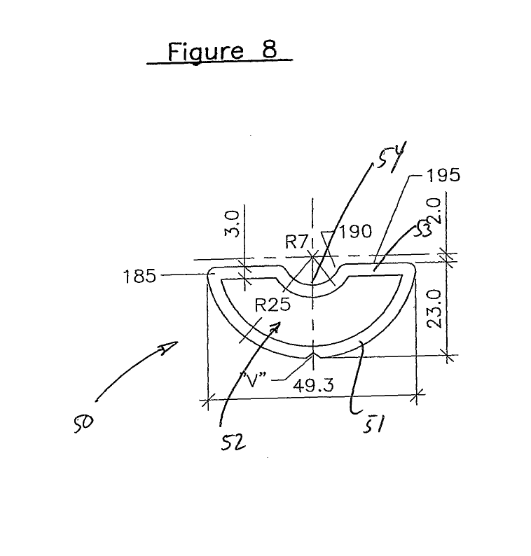

FIG. 5 not only illustrates in greater detail the cross sectional makeup of the luffing poles 50 which are received in the respective roll receiving channels 12a, 12b of support beam 5, but it equally illustrates how a sheet of screening material 80 is secured with its terminal width-ward end onto the composite luffing poles 50, thereby to provide scroll-like unwinding and winding-up capability upon rotation of the luffing poles 60 within their support structure 30. Whilst FIG. 5a provides the same cross-sectional view as seen in FIG. 5 and illustrates typical dimensions of the various components/part of the beam 5, FIG. 8 depicts in cross-sectional illustration a hollow core tubular member 52 which can be assembled pair-wise to provide a substantially hollow core cylindrical luffing pole 50. In other words, luff pole 50 is constructed from two hollow, extruded aluminium tubular member sections 52, of approximately half-hemispherical cross-section, with an outer wall 51 of half circular cross-section which is diametrically spanned by a flat faced wall section 53, with an indent 54 in the centre of flat faced wall 53. In assembling a luff pole 50, the flat faces 53 of two such half-circular tubular members 52 are bought in facing relationship, whereby a small gap is maintained which allows securing of a terminal end of screen material sheet 80, the half-circular tubular members 52 being securable to one another along their longitudinal axis by means of a number of bolts 56 which may be inserted into the hollow spaced through appropriately space, but not illustrated holes in the half circular outer wall 51 of members 52. The terminal free edge of screen material 80 can be thus sandwiched and anchored at the luff poles 50 in a manner that it is possible to wind up and unwind sheet material 80 upon rotation of the luff poles. As illustrated in FIG. 5, the screen material sheet is wound on to the roll core provided by the luff poles 50, in a manner which would cause the left hand role core to rotate in a clock wise direction as the role screening material is unwound towards to the right, hand and visa versa in relation to the left hand role core.

It will be further noted that the axis access of rotation which the luffing poles 50 maintain within the receiving channels of 12a and 12b is located such that screen material 80 is shed from a shed point 57 at the outer periphery of the material role and such that it travels towards and makes contact with the rounded-off terminal ends 19a, 19b of beam 5, before being deflected and extending away from the support posts 30 towards the neighbouring not shown support posts located on the right and left hand sides of the structure 30 illustrated in FIG. 5.

When seeking to tension a length of deployed screen material 80 between adjoining/neighbouring support post structures 30, as described above, the screen material sheet 80 will impart a bending moment on to the luff-poles 50, as these are only supported endwise between the head and bottom anchoring structures 32, 34. The bending forces cause the luffing poles 50 (with the remainder of the wound-up sheet material) to deform along its axis of rotation towards the outer side walls 14a and 14b which border the role-receiving channels 12a, 12b, generally in a direction indicated by arrow B. Once fully tensioned, at least part of the rolled-up screen material 80 on the outer periphery of luffing pole 60 will be bought into tight frictional contact with the inside face of the side walls 14a, 14b, thereby preventing further unravelling of the poles 50, effectively locking the screening material roles in place; i.e. a self-inhibiting arrangement against further unwanted unwinding of roll material is thereby achieved. It will be also observed when viewed either in direction of arrow C or arrow D, that is from the front and rear side of the support structure 30, that there are no gaps between the screening material sheet 80 and the support post 5 through which an observer may detected visually what is occurring on the other side of the erected screen structure, compare also FIG. 10.

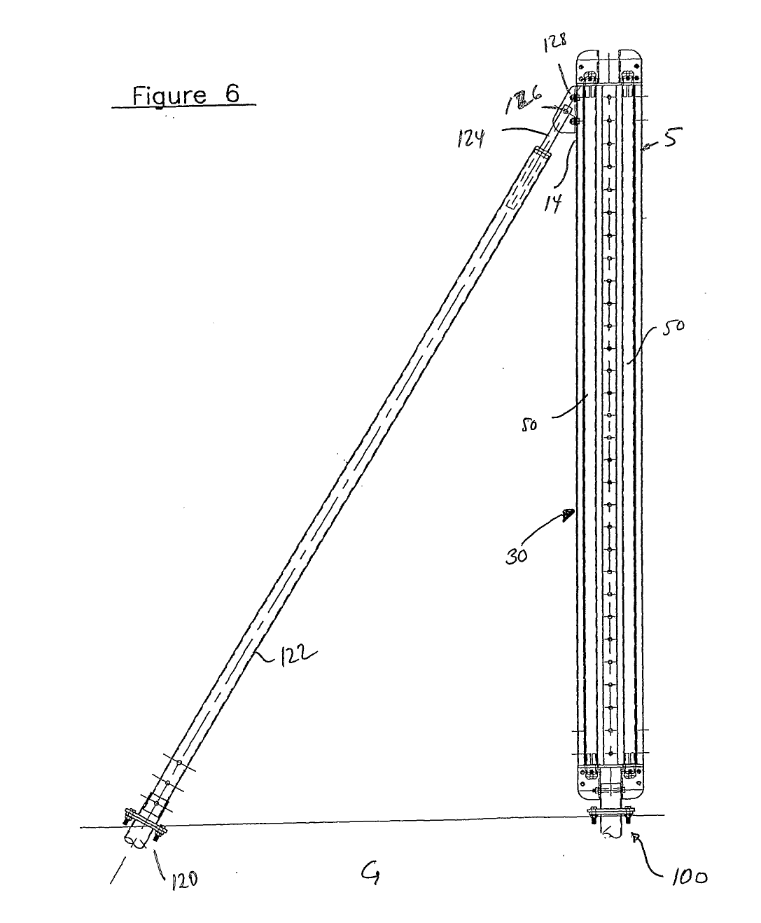

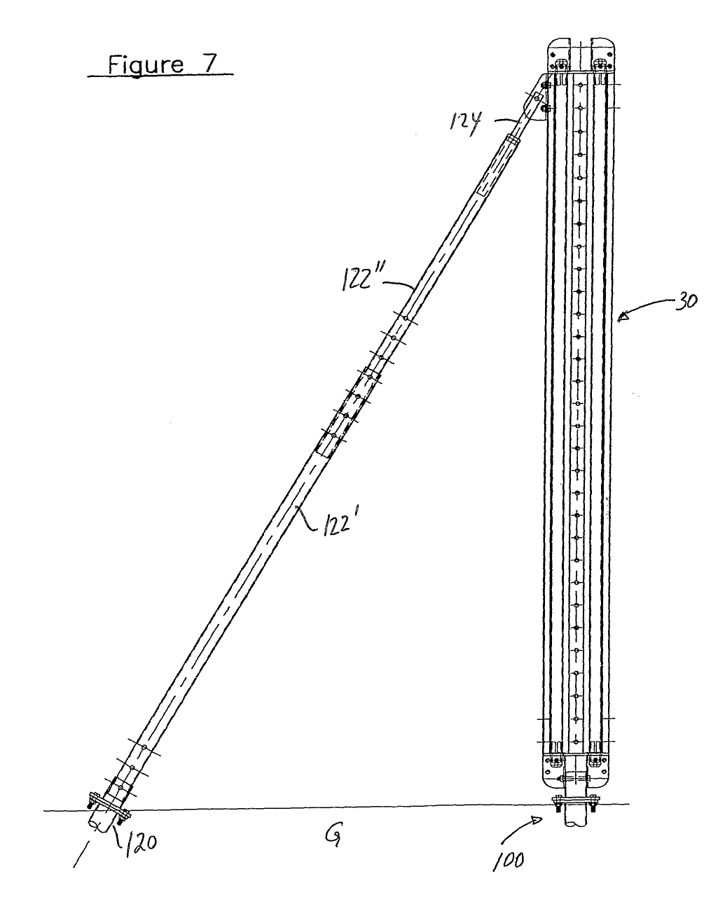

Turning next to FIGS. 6 and 7, these show two different embodiments of additional brassing structures which may assist in strengthening the upright positioning of vertically erected support posts 30 at there ground anchoring structure 100. Whilst FIGS. 6 and 7 show a lateral bracing structure, i.e. bracing against deflection of the support beams 30 towards a neighbouring structure 30, it will be appreciated that such bracing support structure may also be arranged in orthogonal orientation with respect to the drawing plane of FIGS. 6 and 7, i.e. to prevent pivoting of post structure 30 on its ground anchoring structure 100.

Turning first to FIG. 6, the bracing structure there illustrated includes a sunken support pedestal 120 of similar type to the one described in relation to the ground anchoring pedestal structure 100 of the support beam 30, as described above, to which the lower terminal end of bracing rod 122 is anchored using a locking pin or similar. The opposite terminal end of rod 122 has an internal thread into which is threaded in is threaded in length-wise adjustably manner the lower terminal end of an adjustment support rod 124 which in turn is secured via locking pin 126 onto an ear flange 128 which is bolted or otherwise secured onto side wall 14 of beam 5, compare FIG. 1 as well. The threaded engagement between bracing rod 122 and support rod 124 allows for length adjustment of the bracing structure thereby to minimise stresses that load the support structures 30 when erected. The bracing strut arrangement illustrated in FIG. 7 is substantially the same as described with reference to FIG. 6, the difference being that the bracing rod 122 is replaced by a telescopically extendable arrangement consisting of two rods 122′ and 122″, which further increases flexibility of the structure to be deployed on uneven ground and against other structures. The support and bracing structures maybe anchored into the ground via conventional concrete piers) screwed that in the piers or doc blo systems, a known in the art.

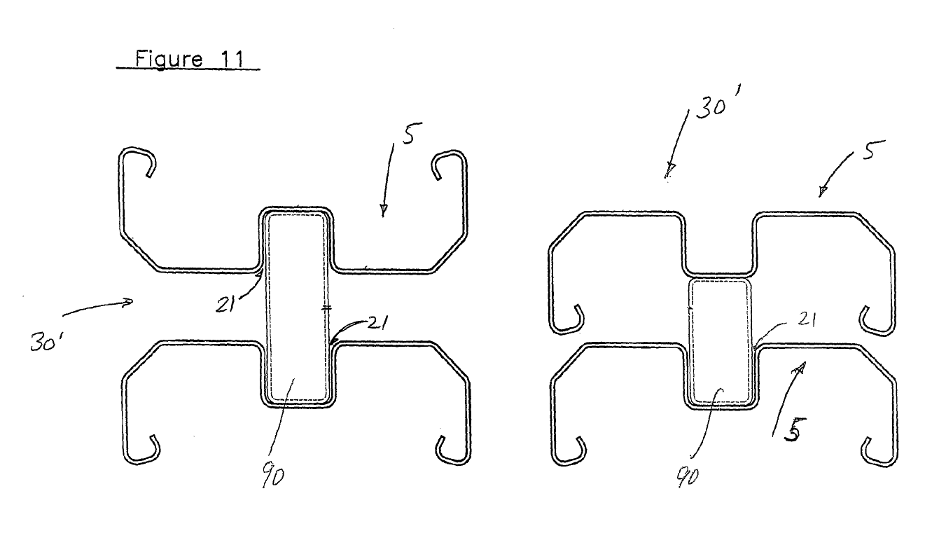

FIG. 11 illustrates two embodiments of a double or twin post arrangement 30′ which is reinforced thereby to provide additional bending stiffness and increase overall rigidity of a support beam structure employed in a screening fence application requiring greater structural soundness, such as to prevent a crashing vehicle from entering a screened off area. To this ends a hollows quadrilateral steel beam 90 maybe form-fittingly received in the central channel 21 of face-wise adjoining beam members 5 and secured thereto using the bolt holes 65 provided along the length of the beams 5, as per FIG. 2. A stacked face-wise arrangement of two beams 5, with a steal beam 90 being received in central channel 21 of one beam 5 and secured against the ridge of the surface 20 is also illustrated.

It would be appreciated by those skilled in the art that the above description is only intended to provide an outline of the inventive concept underlining the present invention and how this may be put in to affect. Variations, which may fall within the scope of the appended claims, of screening structures and support beam arrangements, are also contemplated.

1. An elongate support member for use in a support structure for a screen made from flexible screen material, the support member being shaped to receive two elongate rolls of said screen material, wherein the support member is a visually impenetrable beam having a cross-sectional configuration defining an open W-shaped profile, the profile having two roll-housing channels extending parallel with and along the beam length and opening towards a front side of the beam, the roll-housing channels being dimensioned to receive respective elongate rolls of the screen material, and an intermediate ridge disposed between and partly defining the roll-housing channels and extending parallel with and along the beam, the ridge defining a central channel opening towards a rear side of the beam.

2. The support member according to claim 1, wherein the height of the intermediate ridge is approximately half of the depth of the two roll-housing.

3. The support member according to claim 1, wherein the profile of the beam is symmetrical about a central plane of the intermediate ridge.

4. The support member of according to claim 3, wherein terminal longitudinally extending ends of the profile are rounded to facilitate the smooth transit of screen material across the terminal ends and to provide improved bending strength of the beam.

5. The support member of according to claim 1, wherein the beam is press-formed or roll-formed from a sheet blank.

6. The support member according to claim 5, wherein the blank is about 600 mm wide and about 1-3 mm thick.

7. The support member of according to claim 1, wherein the beam is made from extruded aluminum.

8. The support member according to claim 1, wherein the profile of the roll-housing channels is defined by a flat rear wall connected to said intermediate ridge and connected to a flat outer side wall by a bevelled return wall.

9. The support member according to claim 8, wherein the profile of the roll-housing channel is further defined by a flat outer side wall having a terminal end, wherein said terminal end features a rounded return surface.

10. An elongate support member for use in a support structure for a screen made from flexible screen material substantially as herein described with reference to the figures.

11. An erectable screening structure, including a sheet of opaque flexible screen material having terminal ends anchored at two elongate roll cores in a scroll-like configuration allowing unwinding and winding-up of screen material onto one or both rolls; first and second support structures each of which include a support element (beam) as defined above and which further include header and footer anchoring structures close or at longitudinally opposite ends of the beams; and two ground anchoring structures devised to allow vertical anchoring of the two support structures in spaced apart relationship on the ground, wherein said roll cores are secured to said support members between said header and footer members in rotatable manner and located in a respective one of the roll-housing channels of the respective beams that are closest to one another, and wherein said screen material, In deployed state, extends from a shed point on the outer periphery of the roll located in the roll-housing channel of the first support structure, via contact with the immediately adjacent terminal end of the profile of the first support structure beam, towards said second support structure, via contact with the immediately adjacent terminal end of the profile of said second support structure beam, to a shed point on the outer periphery of the roll located in the roll-housing channel of the second support structure beam, thereby to create a visually substantially impenetrable zone where the screen material meets the support structure beams.

12. The screening structure according to claim 11, wherein the roll cores are flexible about a longitudinal axis thereof to an extent that they may bend and allow the outer surface of said rolls to make frictional contact with the inner surface of the roll-housing channels of the support members when the screen material is placed in tension and thereby substantially prevent rotation of said roll cores at the support members.

13. The screen structure according to claim 12, wherein the respective axis of rotation of each roll core received at the associated support member, when not subjected to tension, is coplanar with the terminal surface of the intermediate ridge of the support member.

14. The screen structure according to claim 12, wherein the screen material is rolled on to the roll core in a manner which would tend to cause the roll core to deform toward the outer wall of the roll-housing channels of the support members when said screen material is placed in tension.

15. A screen structure according to claim 11, wherein the footer anchoring structure is devised to pivotally mount the support members onto the anchoring structures deployed on the ground.

16. A screen structure substantially as herein described, with reference to the figures.
